(19) United States
(12) Patent Application Publication
(10) Pub. No.: US 2026/0080664 A1
(43) Pub. Date: Mar. 19, 2026

(54) CLASS CLASSIFICATION METHOD, CLASS CLASSIFICATION DEVICE, NON-TRANSITORY COMPUTER READABLE RECORDING MEDIUM STORING CLASS CLASSIFICATION PROGRAM, LEARNING METHOD, LEARNING DEVICE, AND NON-TRANSITORY COMPUTER READABLE RECORDING MEDIUM STORING LEARNING PROGRAM

(71) Applicant: PANASONIC INTELLECTUAL PROPERTY MANAGEMENT CO., LTD., Osaka (JP)

(72) Inventors: Jumpei GOTO, Osaka (JP); Kiyofumi ABE, Osaka (JP); Yohei NAKATA, Osaka (JP)

(73) Assignee: PANASONIC INTELLECTUAL PROPERTY MANAGEMENT CO., LTD., Osaka (JP)

(21) Appl. No.: 19/400,628

(22) Filed: Nov. 25, 2025

Related U.S. Application Data
(63) Continuation of application No. PCT/JP2024/017081, filed on May 8, 2024.
(60) Provisional application No. 63/469,650, filed on May 30, 2023.

(30) Foreign Application Priority Data
Apr. 1, 2024 (JP) 2024-058882

(51) Int. Cl. G06V 10/764; G06V 10/40

(52) U.S. Cl. CPC G06V 10/764; G06V 10/40

(57) ABSTRACT

This class classification device: acquires feature vectors extracted from input data; generates, by using a trained generator, weight vectors that continuously change according to the values of the feature vectors, for a plurality of classes to be classified; calculates, by using a trained calculator, scores for the plurality of classes on the basis of the feature vectors and a plurality of the weight vectors generated for the plurality of classes; classifies a classification target of the input data into any of the plurality of classes on the basis of a plurality of the scores calculated for the plurality of classes; and outputs the classification result.

### FIELD OF INVENTION

The present disclosure relates to a technology for performing class classification using a deep learning model and a technology for learning a deep learning model used for performing class classification.

### BACKGROUND ART

Conventionally, in a class classification task, a linear classifier that assigns one weight vector to each class is used as a classifier. Therefore, when a feature amount according to a multimodal distribution is input to the classifier, it is difficult to classify the input image from the feature amount.

In order to solve such a problem, for example, Non Patent Literature 1 proposes a method of expressing a plurality of classes with a plurality of weight vectors instead of one weight vector.

However, in the above-described conventional technique, it is difficult to accurately perform class classification in a case where feature amounts in a class are distributed in a wide range, and further improvement has been required.
Non Patent Literature 1: Wenguan Wang, Cheng Han, Tianfei Zhou, Dongfang Liu, “Visual Recognition with Deep Nearest Centroids”, ICLR2023, Feb. 2, 2023

### SUMMARY OF THE INVENTION

The present disclosure has been made to solve the above problem, and an object of the present disclosure is to provide a technology capable of accurately performing class classification even in a case where feature amounts within a class are distributed in a wide range.

A class classification method according to the present disclosure is a class classification method executed by a computer, including acquiring a feature vector extracted from input data, generating a weight vector continuously changing according to a value of the feature vector for each of a plurality of classes to be classified using a trained generator, calculating a score for each of the plurality of classes based on the feature vector and a plurality of weight vectors generated for each of the plurality of classes using a trained calculator, classifying a classification target of the input data into any one of the plurality of classes based on a plurality of scores calculated for each of the plurality of classes; and outputting a classification result.

According to the present disclosure, class classification can be accurately performed even in a case where feature amounts within a class are distributed in a wide range.

### BRIEF DESCRIPTION OF THE DRAWINGS

FIG. 1 is a block diagram illustrating a configuration of a class classification device according to the present embodiment.

FIG. 2 is a block diagram illustrating a configuration of a first weight generation part illustrated in FIG. 1.

FIG. 3 is a block diagram illustrating a configuration of a learning device in the present embodiment.

FIG. 4 is a flowchart for explaining an operation of the class classification device according to the present embodiment.

FIG. 5 is a flowchart for explaining an operation of the learning device according to the present embodiment.

FIG. 6 is a diagram illustrating a distribution of feature amounts in a feature amount space in conventional class classification by DNC.

FIG. 7 is a diagram illustrating a distribution of feature amounts in a feature amount space in class classification by the class classification device according to the present embodiment.

FIG. 8 is a diagram illustrating evaluation results of two conventional class classification methods for two data sets and the class classification method according to the present embodiment.

FIG. 9 is a diagram illustrating evaluation results of two conventional class classification methods for two types of labels of the CIFAR-20 and the class classification method of the present embodiment.

FIG. 10 is a diagram illustrating evaluation results of two conventional class classification methods for two types of labels of ImageNet and the class classification method of the present embodiment.

### DETAILED DESCRIPTION

### (Knowledge Underlying Present Disclosure)

Conventionally, class classification tasks are used in various tasks such as image identification, object detection, and semantic segmentation, and improvement of classification accuracy is an important problem. In general, a network model that performs class classification includes a backbone that extracts feature amounts from an image, and a classifier that performs classification of each class from the extracted feature amounts. The classifier identifies a class by comparing magnitudes of scores (similarity) obtained by an inner product of one weight vector and a feature amount for each class. In recent years, in order to improve classification performance, the number of input images is increased, the types of input images are increased, and the distribution of the input images is diversified. As the distribution of the input image is diversified, the data set of each class cannot be expressed by a single set in the feature amount space, and the distribution of the data set has multimodality. At this time, it is difficult to express the distribution in the class with one weight vector.

In order to solve such a problem, Non Patent Literature 1 proposes a method of expressing a plurality of classes with a plurality of weight vectors instead of one weight vector. The method computes a plurality of centroid vectors (clustering centroids) in each class through online clustering to obtain complex feature representations in each class. In the inference processing, a centroid vector closest to the feature amount extracted from the input image is searched, and a class to which the found centroid vector belongs is output as an inference result. That is, in this method, since one selected centroid vector is used for class identification, the other centroid vectors that are not selected are not used for learning. For example, even in a case where the input image has a feature common to two centroid vectors, learning is performed so as to forcibly assign the input image to the centroid vector of one of the two centroid vectors, and the parameter is updated using an error with respect to the assigned centroid vector. Therefore, when the feature amounts in the class are distributed in a wide range, it is difficult for the backbone to accurately learn the property of the feature amounts, and it is difficult to accurately perform class classification.

In order to solve the above problem, the following technique is disclosed.

(1) A class classification method according to one aspect of the present disclosure is a class classification method executed by a computer, including acquiring a feature vector extracted from input data, generating a weight vector continuously changing according to a value of the feature vector for each of a plurality of classes to be classified using a trained generator, calculating a score for each of the plurality of classes based on the feature vector and a plurality of weight vectors generated for each of the plurality of classes using a trained calculator, classifying a classification target of the input data into any one of the plurality of classes based on a plurality of scores calculated for each of the plurality of classes; and outputting a classification result.

According to this configuration, the weight vector continuously changing according to the value of the feature vector is generated for each of the plurality of classes to be classified. Then, a score for each of the plurality of classes is calculated based on the feature vector and the plurality of weight vectors generated for each of the plurality of classes. Then, the classification target of the input data is classified into any of the plurality of classes based on the plurality of scores calculated for each of the plurality of classes.

Therefore, since the weight vector continuously changing according to the value of the feature vector is generated for each of the plurality of classes to be classified, a plurality of variations of the feature amount in the class can be expressed, and the class classification can be accurately performed even when the feature amount in the class is distributed in a wide range.

(2) In the class classification method according to (1), the generator may have a matrix including a plurality of row vectors as a parameter for each class of the plurality of classes, and the generating of the weight vector may include generating the weight vector for each class using the value of the feature vector and the matrix.

According to this configuration, it is possible to generate a weight vector for each class using the value of the feature vector and the matrix.

(3) In the class classification method according to (2), the generating of the weight vector may include, for each class of the plurality of classes, calculating a weight of a linear combination for each of a plurality of row vectors constituting a matrix allocated to each class from a value of the feature vector and the plurality of row vectors, and generating a weight vector for each class by linearly combining the plurality of row vectors using the weight.

According to this configuration, the feature vector can be assigned to each element of each matrix by a continuous value, and a plurality of variations of the feature amount in the class can be expressed.

(4) In the class classification method according to (2), the matrix may be an orthonormal matrix. According to this configuration, since the multimodality of data can be expressed by the orthogonal basis, classification performance can be improved.

(5) In the class classification method according to (3), each element of the weights of the linear combination may be positive. According to this configuration, interpretability can be enhanced with respect to a plurality of variations of the feature amount in the class.

(6) In the class classification method according to any one of (1) to (5), the input data may be image data. According to this configuration, the classification target of the image data can be classified into any of a plurality of classes.

(7) In the class classification method according to (6), the classification target of the input data may be the image data. According to this configuration, class classification can be performed for each piece of image data like image identification.

(8) In the class classification method according to (6), the classification target of the input data may be each of a plurality of pixels constituting the image data. According to this configuration, class classification can be performed for each of a plurality of pixels constituting image data like semantic segmentation.

(9) In the class classification method according to (6), the classification target of the input data may be a bounding box surrounding an object included in the image data. According to this configuration, class classification can be performed for each bounding box surrounding an object included in image data like object detection.

(10) In the class classification method according to any one of (1) to (5), the input data may be time-series data. According to this configuration, the classification target of the time-series data can be classified into any of a plurality of classes.

(11) A learning method according to another aspect of the present disclosure is a learning method executed by a computer, including acquiring a feature vector extracted from input data, generating a weight vector that continuously changes according to a value of the feature vector for each of a plurality of classes to be classified using an untrained generator, calculating a score for each of the plurality of classes based on the feature vector and a plurality of weight vectors generated for each of the plurality of classes using an untrained calculator, calculating an error between a plurality of scores calculated for each of the plurality of classes and a correct answer label associated with a classification target of the input data, and updating a parameter of at least one of the generator and the calculator based on the error.

According to this configuration, the weight vector continuously changing according to the value of the feature vector is generated for each of the plurality of classes to be classified. Then, a score for each of the plurality of classes is calculated based on the feature vector and the plurality of weight vectors generated for each of the plurality of classes. Then, the parameter of at least one of the generator and the calculator is updated based on an error between the plurality of scores calculated for each of the plurality of classes and the correct answer label associated with the classification target of the input data.

Therefore, since the weight vector continuously changing according to the value of the feature vector is generated for each of the plurality of classes to be classified, the generator and the calculator trained using the generated weight vector can express a plurality of variations of the feature amount in the class, and class classification can be accurately performed even when the feature amount in the class is distributed in a wide range.

(12) In the learning method according to (11), the generator may have a matrix including a plurality of row vectors as a parameter for each class of the plurality of classes, and the generating of the weight vector may include generating the weight vector for each class using the value of the feature vector and the matrix.

According to this configuration, it is possible to generate a weight vector for each class using the value of the feature vector and the matrix.

(13) In the learning method according to (12), the generating of the weight vector may include, for each class of the plurality of classes, calculating a weight of a linear combination for each of a plurality of row vectors constituting a matrix allocated to each class from a value of the feature vector and the plurality of row vectors, and generating a weight vector for each class by linearly combining the plurality of row vectors using the weight.

According to this configuration, the feature vector can be assigned to each element of each matrix by a continuous value, and a plurality of variations of the feature amount in the class can be expressed.

(14) In the learning method according to (12), the matrix may be an orthonormal matrix. According to this configuration, since the multimodality of data can be expressed by the orthogonal basis, classification performance can be improved.

(15) In the learning method according to (13), each element of the weights of the linear combination may be positive. According to this configuration, interpretability can be enhanced with respect to a plurality of variations of the feature amount in the class.

(16) The learning method according to any one of (11) to (15) may further include extracting the feature vector from the input data using an untrained extractor, and the updating of the parameter may include simultaneously updating the parameter of each of the extractor, the generator, and the calculator based on the error.

In particular, in Non Patent Literature 1, since the parameter of the feature amount extractor and the parameter of the weight generator are alternately updated by online clustering, it is difficult to simultaneously update the parameters of the feature amount extractor and the weight generator. On the other hand, in the above configuration, the parameters of the extractor, the generator, and the calculator can be simultaneously updated by, for example, the error back propagation method or the gradient descent method.

The present disclosure can be implemented not only as a class classification method for executing the characteristic processing as described above, but also as a class classification device or the like having a characteristic configuration corresponding to characteristic processing executed by the class classification method. In addition, it is also possible to realize a computer program that causes a computer to execute the characteristic processing included in the above-described class classification method. Therefore, an effect similar to the effect in the above class classification method can also be achieved by another aspect described below.

(17) A class classification device according to another aspect of the present disclosure includes an acquisition part that acquires a feature vector extracted from input data, a generation part that generates a weight vector continuously changing according to a value of the feature vector for each of a plurality of classes to be classified using a trained generator, a score calculation part that calculates a score for each of the plurality of classes based on the feature vector and a plurality of weight vectors generated for each of the plurality of classes using a trained calculator, a classification part that classifies a classification target of the input data into any one of the plurality of classes based on a plurality of scores calculated for each of the plurality of classes, and an output part that outputs a classification result.

(18) A class classification program according to another aspect of the present disclosure causes a computer to execute acquiring a feature vector extracted from input data, generating a weight vector continuously changing according to a value of the feature vector for each of a plurality of classes to be classified using a trained generator, calculating a score for each of the plurality of classes based on the feature vector and a plurality of weight vectors generated for each of the plurality of classes using a trained calculator, classifying a classification target of the input data into any one of the plurality of classes based on a plurality of scores calculated for each of the plurality of classes, and outputting a classification result.

(19) A non-transitory computer-readable recording medium according to another aspect of the present disclosure records the class classification program.

The present disclosure can be implemented not only as a learning method for executing the characteristic processing as described above, but also as a learning device or the like having a characteristic configuration corresponding to characteristic processing executed by the learning method. The characteristic process included in such a learning method can also be implemented as a computer program to be executed by a computer. Therefore, the following other aspects can also produce the same effect as the above-described learning method.

(20) A learning device according to another aspect of the present disclosure includes an acquisition part that acquires a feature vector extracted from input data, a generation part that generates a weight vector that continuously changes according to a value of the feature vector for each of a plurality of classes to be classified using an untrained generator, a score calculation part that calculates a score for each of the plurality of classes based on the feature vector and a plurality of weight vectors generated for each of the plurality of classes using an untrained calculator, an error calculation part that calculates an error between a plurality of scores calculated for each of the plurality of classes and a correct answer label associated with a classification target of the input data, and an update part that updates a parameter of at least one of the generator and the calculator based on the error.

(21) A learning program according to another aspect of the present disclosure causes a computer to execute acquiring a feature vector extracted from input data, generating a weight vector that continuously changes according to a value of the feature vector for each of a plurality of classes to be classified using an untrained generator, calculating a score for each of the plurality of classes based on the feature vector and a plurality of weight vectors generated for each of the plurality of classes using an untrained calculator, calculating an error between a plurality of scores calculated for each of the plurality of classes and a correct answer label associated with a classification target of the input data, and updating a parameter of at least one of the generator and the calculator based on the error.

(22) A non-transitory computer-readable recording medium according to another aspect of the present disclosure records the learning program.

Embodiments of the present disclosure will be described below with reference to the accompanying drawings. Note that each of embodiments described below illustrates a specific example of the present disclosure. Numerical values, shapes, constituent elements, steps, order of steps, and the like of the embodiment below are merely examples, and are not intended to limit the present disclosure. A constituent element not described in an independent claim representing a highest concept among constituent elements in the embodiments below is described as an optional constituent element. Furthermore, in all the embodiments, respective contents can be combined.

### Embodiments

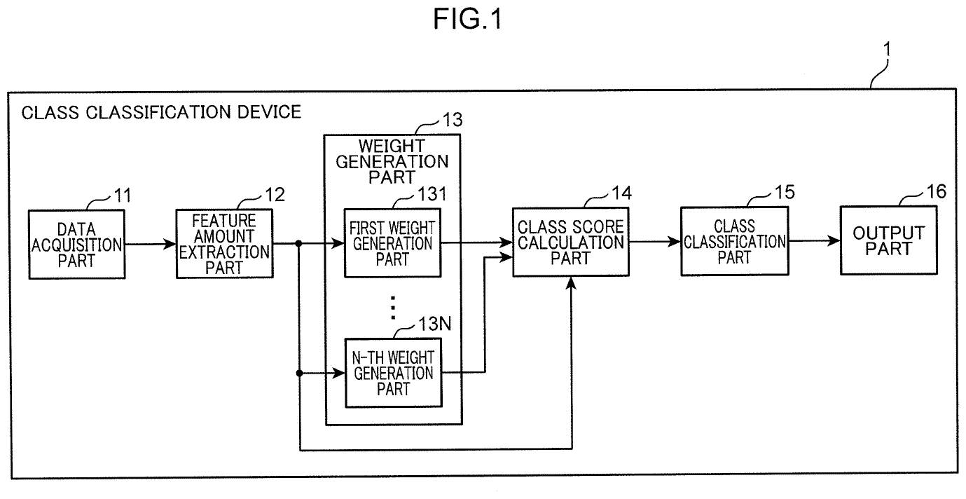

FIG. 1 is a block diagram illustrating a configuration of a class classification device 1 according to the present embodiment.

The class classification device 1 includes at least a computer system including, for example, a control program, a processing circuit such as a processor or a logic circuit that executes the control program, and a recording device such as an internal memory or an accessible external memory that stores the control program. Note that the class classification device 1 may be implemented by, for example, hardware implementation by a processing circuit, execution of a software program held in a memory by the processing circuit or distributed from an external server, or a combination of the hardware implementation and the software implementation.

The class classification device 1 illustrated in FIG. 1 includes a data acquisition part 11, a feature amount extraction part 12, a weight generation part 13, a class score calculation part 14, a class classification part 15, and an output part 16.

The data acquisition part 11 acquires image data including a class classification target. The image data is an example of input data. Note that the data acquisition part 11 may receive image data from an external device via a communication part (not illustrated), or may read image data stored in a memory (not illustrated). Examples of the external device include a personal computer, a server, and a camera. The data acquisition part 11 may acquire the image data according to an acquisition instruction from the user. In addition, in the present specification, the image data may be simply referred to as an image.

The feature amount extraction part 12 extracts a feature vector from the image data acquired by the data acquisition part 11 using the trained extraction model (extractor). The feature amount extraction part 12 extracts a d-dimensional feature vector corresponding to the number of classes to be classified. The feature amount extraction part 12 inputs the image data acquired by the data acquisition part 11 to the extraction model, and acquires a feature vector output from the extraction model. The extraction model is trained by deep learning which is one of machine learning methods.

The weight generation part 13 acquires a feature vector extracted from the image data. The weight generation part 13 acquires the feature vector extracted by the feature amount extraction part 12. The weight generation part 13 uses a trained generation model (generator) to generate, for each of a plurality of classes for classification, a weight vector that continuously changes according to a value of a feature vector. The generation model has a matrix including a plurality of row vectors as a parameter for each of a plurality of classes. The weight generation part 13 generates a weight vector for each class using the value of the feature vector and the matrix. For each class of the plurality of classes, the weight generation part 13 calculates the weight of the linear combination for each of the plurality of row vectors from the value of the feature vector and the plurality of row vectors constituting the matrix allocated to each class, and generates the weight vector for each class by linearly combining the plurality of row vectors using the weight. The matrix is an orthonormal matrix. Each element of the weight of the linear combination is positive.

The weight generation part 13 includes a first weight generation part 131 to an N-th weight generation part 13N according to the number of classes to be classified. For example, in a case where the number of classes to be classified is three, the weight generation part 13 includes the first weight generation part 131 to the third weight generation part 133. The first weight generation part 131 to the N-th weight generation part 13N generate weight vectors corresponding to the first class to the N-th class to be classified, respectively.

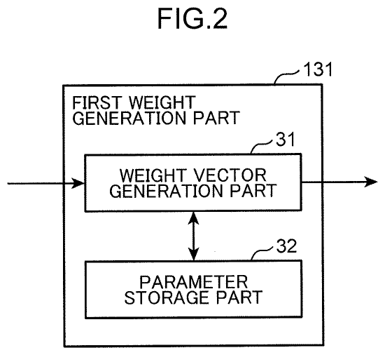

FIG. 2 is a block diagram illustrating a configuration of the first weight generation part 131 illustrated in FIG. 1. Note that the configurations of the second weight generation part 132 to the N-th weight generation part 13N are the same as the configuration of the first weight generation part 131.

The first weight generation part 131 includes a weight vector generation part 31 and a parameter storage part 32. The weight vector generation part 31 calculates the weight of the linear combination for each of the plurality of row vectors from the value of the feature vector and the plurality of row vectors constituting the matrix allocated to the first class, and generates the weight vector for the first class by linearly combining the plurality of row vectors using the weight. The weight vector generation part 31 inputs the feature vector extracted by the feature amount extraction part 12 to the generation model, and acquires the weight vector corresponding to the first class output from the generation model. The generation model is trained by deep learning which is one of machine learning methods. The parameter storage part 32 stores in advance parameters to be used for the trained generation model. The parameter is a matrix allocated to the first class.

The class score calculation part 14 uses a trained calculation model (calculator) to calculate a score for each of a plurality of classes based on the feature vector extracted by the feature amount extraction part 12 and the plurality of weight vectors generated for each of the plurality of classes by the weight generation part 13. The class score calculation part 14 inputs the feature vector and the plurality of weight vectors to the calculation model and acquires a score output from the calculation model. The calculation model is trained by deep learning which is one of machine learning.

The class classification part 15 classifies the classification target of the image data into any of the plurality of classes based on the plurality of scores calculated for each of the plurality of classes by the class score calculation part 14. The class classification part 15 classifies the classification target of the image data into a class corresponding to the highest score among the plurality of scores calculated by the class score calculation part 14.

The output part 16 outputs a classification result by the class classification part 15. For example, the output part 16 may output the classification result to a display part connected to the class classification device 1. The display part may display the classification result. Note that the output part 16 may output the acquired image data and the classification result to the display part.

The deep nearest centroids (DNC) of Non Patent Literature 1 has a problem that it is necessary to assign the feature amount z to a certain centroid vector w^{c}ᵢ when the feature amount z belonging to the class c is given for convenience of performing online clustering. That is, even when the similarity sim (w^{c}ᵢ, z) is substantially equal to the similarity sim (w^{c}ᵢ, z), the feature amount is allocated to either the centroid vector w^{c}ᵢ or the centroid vector w^{c}ᵢ. For example, if sim (w^{c}ᵢ, z)>sim(w^{c}ⱼ, z), the feature amount z is trained so as to approach the centroid vector w^{c}ᵢ, and the property of being similar to the centroid vector w^{c}ⱼ is ignored.

Therefore, the class classification device 1 of the present embodiment uses the matrix W^{c}∈R^{n*d} including n (<d) weight vectors, so that the multimodal distribution of the feature amount z in the feature amount space can be expressed without using online clustering.

Specifically, the similarity between the feature amount z and the matrix W^{c} is calculated by the expression sim (W^{cT}a^{c}, z). At this time, the assignment vector is a continuous value (a^{c}∈Rⁿ₊) so that the matrix W^{c} can be updated by the gradient descent method without using online clustering.

Using the L2 distance with temperature as similarity, the logit function l_{c}(z;κ) is represented by the following Expression (1).

$$[ Math . 1 ]$$

$${ℓ}_{c} ( z ; κ ) = - κ {‖ z - {W}^{cT} {a}^{c} ‖}_{2}^{2} \qquad ( 1 )$$

Note that, in the above Expression (1), κ is a hyperparameter larger than 0, z is a feature vector, W^{cT} is a transposed matrix of the matrix W^{c}, and a^{c} is an assignment vector.

Here, the matrix W^{c} is an orthonormal matrix. That is, the matrix W^{c} satisfies the constraint of W^{c}W^{cT}=Iₙ. W^{cT} is a transposed matrix of the matrix W^{c}, and Iₙ is an n-dimensional identity matrix. As a result, the matrix W^{c} is always full rank. Furthermore, due to the orthonormality of the matrix W^{c}, a positive assignment vector a^{c}=ReLU (W^{c}z) is set so as to minimize the L2 distance of the above Expression (1). Therefore, in a case where the matrix W^{c} is an orthonormal matrix, the logit function of the above Expression (1) is expressed by the following Expression (2).

$$[ Math . 2 ]$$

$${ℓ}_{c} ( z ; κ ) = - κ {‖ z - {W}^{cT} ReLU ( {W}^{c} z ) ‖}_{2}^{2} \qquad ( 2 )$$

Note that, in the above Expression (2), κ is a hyperparameter larger than 0, z is a feature vector, W^{c} is a matrix of class c (c=1, 2, . . . , C), W^{cT} is a transposed matrix of the matrix W^{c}, ReLU is an activation function, and is also referred to as a normalized linear unit.

Similarly to the DNC, when the feature amount is performed L2 normalization and the constant term is removed, the logit function of the above Expression (2) is expressed by the following Expression (3).

$$[ Math . 3 ]$$

$${ℓ}_{c} ( z ; κ ) = κ {‖ ReLU ( {W}^{c} z ) ‖}_{2}^{2} \qquad ( 3 )$$

W^{cT}ReLU(W^{c}z) in Expression (2) represents a weight vector of each class generated by the weight generation part 13. In addition, the logit function l_{c}(z;K) in Expressions (2) and (3) represents the score of each class calculated by the class score calculation part 14.

In the present embodiment, in order to improve interpretability in the framework of prototype learning, a model having high interpretability for variations in a class is proposed by making a weight vector in class classification into a matrix and imposing an orthogonal constraint on the weight matrix.

Subsequently, a configuration of a learning device 2 according to the present embodiment will be described.

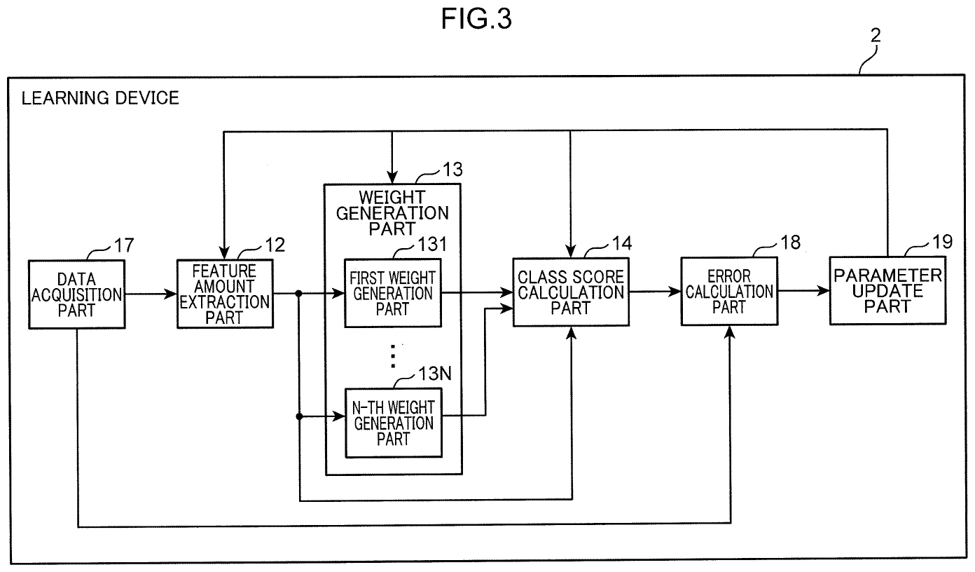

FIG. 3 is a block diagram illustrating a configuration of the learning device 2 in the present embodiment.

The learning device 2 includes at least a computer system including, for example, a control program, a processing circuit such as a processor or a logic circuit that executes the control program, and a recording device such as an internal memory or an accessible external memory that stores the control program. Note that the learning device 2 may be implemented by, for example, hardware implementation by a processing circuit, execution of a software program held in a memory by the processing circuit or distributed from an external server, or a combination of the hardware implementation and the software implementation.

The learning device 2 illustrated in FIG. 3 includes a data acquisition part 17, a feature amount extraction part 12, a weight generation part 13, a class score calculation part 14, an error calculation part 18, and a parameter update part 19. Note that, in the learning device 2 illustrated in FIG. 3, the same components as those of the class classification device 1 illustrated in FIG. 1 are denoted by the same reference numerals, and description thereof is omitted.

The data acquisition part 17 acquires image data including a class classification target and a correct answer label associated with the class classification target of the image data. The image data is an example of input data. The image data and the correct answer label are training data used for machine learning. Note that the data acquisition part 17 may receive the image data and the correct answer label from an external device via a communication part (not illustrated), or may read the image data and the correct answer label stored in a memory (not illustrated). Examples of the external device include a personal computer and a server. The data acquisition part 17 may acquire the image data and the correct answer label according to an acquisition instruction from the user. In addition, in the present specification, the image data may be simply referred to as an image.

The feature amount extraction part 12 extracts a feature vector from the image data acquired by the data acquisition part 17 using the untrained extraction model (extractor). The weight generation part 13 uses an untrained generation model (generator) to generate, for each of a plurality of classes for classification, a weight vector that continuously changes according to a value of a feature vector. The class score calculation part 14 uses an untrained calculation model (calculator) to calculate a score for each of a plurality of classes based on the feature vector extracted by the feature amount extraction part 12 and the plurality of weight vectors generated for each of the plurality of classes by the weight generation part 13.

The error calculation part 18 calculates an error between the plurality of scores calculated for each of the plurality of classes by the class score calculation part 14 and the correct answer label associated with the classification target of the image data. The error calculation part 18 calculates a cross entropy error for each of the plurality of classes by substituting a plurality of scores and correct answer labels into the loss function. The loss function is expressed by the following Expression (4) using a logit function l_{c}(z;K).

$$[ Math . 4 ]$$

$$- \frac{1}{N} {\sum }_{( {x}_{i} , {y}_{i} ) ∈ 𝒯} log ( \frac{exp ( {ℓ}_{{y}_{i}} ( {f}_{θ} ( {x}_{i} ) ; κ ) )}{{\sum }_{k = 1}^{C} exp ( {ℓ}_{k} ( {f}_{θ} ( {x}_{i} ) ; κ ) )} ) \qquad ( 4 )$$

In the above Expression (4), xᵢ represents image data, yᵢ represents a correct answer label of the image data, and f_{θ}(xᵢ) represents a feature vector of the image data xᵢ.

The parameter update part 19 updates the parameters of each of the extraction model, the generation model, and the calculation model based on the error calculated by the error calculation part 18. The parameter update part 19 simultaneously updates the parameters of the extraction model, the generation model, and the calculation model by an error back propagation method such that the error calculated by the error calculation part 18 is minimized. Specifically, the parameter of the generation model is a plurality of matrices for each of a plurality of classes, and the parameter update part 19 updates the plurality of matrices.

Note that, in the present embodiment, the parameter update part 19 updates the parameters of each of the extraction model, the generation model, and the calculation model in one learning; however, the present disclosure is not particularly limited thereto, and at least one parameter of the extraction model, the generation model, and the calculation model may be updated in one learning.

Note that the softmax cross entropy error minimization problem using the logit function l_{c}(z;k) is expressed by the following Expression (5).

$$[ Math . 5 ]$$

$${minimize}_{θ , {W}^{1} , … , {W}^{C}} - \frac{1}{N} {\sum }_{( {x}_{i} , {y}_{i} ) ∈ 𝒯} log ( \frac{exp ( {ℓ}_{{y}_{i}} ( {f}_{θ} ( {x}_{i} ) ; κ ) )}{{\sum }_{k = 1}^{C} exp ( {ℓ}_{k} ( {f}_{θ} ( {x}_{i} ) ; κ ) )} ) \qquad ( 5 )$$

$$subject to {W}^{c} {W}^{cT} = {I}_{n} , c = 1 , 2 , … , C$$

This problem is an optimization problem with an orthogonal constraint. For such an optimization problem with an orthogonal constraint, for example, conventionally, the Lagrange multiplier is used and the orthogonal constraint is added to the regularization term of the objective function. This method is effective from the viewpoint of calculation time when there are many orthogonal constraints, but it is necessary to adjust the regularization parameter. Therefore, in the present embodiment, since the orthogonal constraint is only the weight matrix W^{c}, Riemannian Optimization is adopted for the optimization.

The learning device 2 of the present embodiment learns by using a value obtained by projecting a feature vector with an orthonormal matrix. By using the feature vector projected with the orthonormal matrix for classification, the multimodality of data can be expressed by the orthogonal basis, so that the classification performance can be improved.

Next, an operation of the class classification device 1 according to the present embodiment will be described.

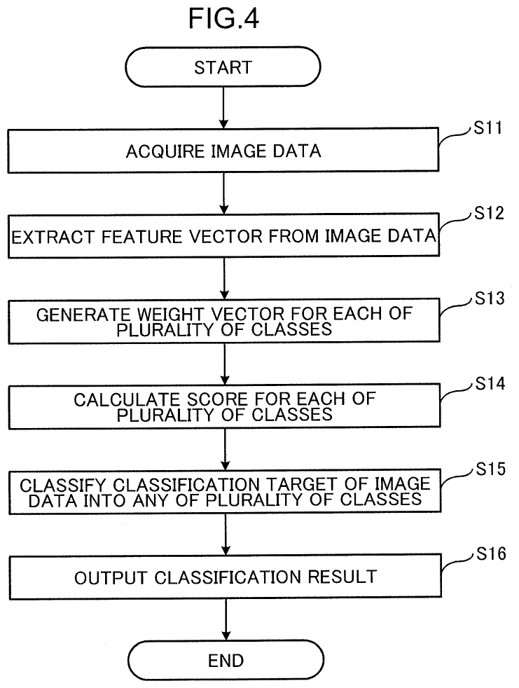

FIG. 4 is a flowchart for explaining the operation of the class classification device 1 according to the present embodiment.

First, in step S11, the data acquisition part 11 acquires image data including a class classification target.

Next, in step S12, the feature amount extraction part 12 extracts a feature vector from the image data acquired by the data acquisition part 11 using the trained extraction model.

Next, in step S13, the weight generation part 13 uses a trained generation model to generate, for each of a plurality of classes for classification, a weight vector that continuously changes according to a value of a feature vector.

Next, in step S14, the class score calculation part 14 uses a trained calculation model to calculate a score for each of a plurality of classes based on the feature vector extracted by the feature amount extraction part 12 and the plurality of weight vectors generated for each of the plurality of classes by the weight generation part 13.

Next, in step S15, the class classification part 15 classifies the classification target of the image data into any of the plurality of classes based on the plurality of scores calculated for each of the plurality of classes by the class score calculation part 14.

Next, in step S16, the output part 16 outputs a classification result by the class classification part 15.

As described above, the weight vector continuously changing according to the value of the feature vector is generated for each of the plurality of classes to be classified. Then, a score for each of the plurality of classes is calculated based on the feature vector and the plurality of weight vectors generated for each of the plurality of classes. Then, the classification target of the input data is classified into any of the plurality of classes based on the plurality of scores calculated for each of the plurality of classes.

Therefore, since the weight vector continuously changing according to the value of the feature vector is generated for each of the plurality of classes to be classified, a plurality of variations of the feature amount in the class can be expressed, and the class classification can be accurately performed even when the feature amount in the class is distributed in a wide range.

Subsequently, an operation of the learning device 2 according to the present embodiment will be described.

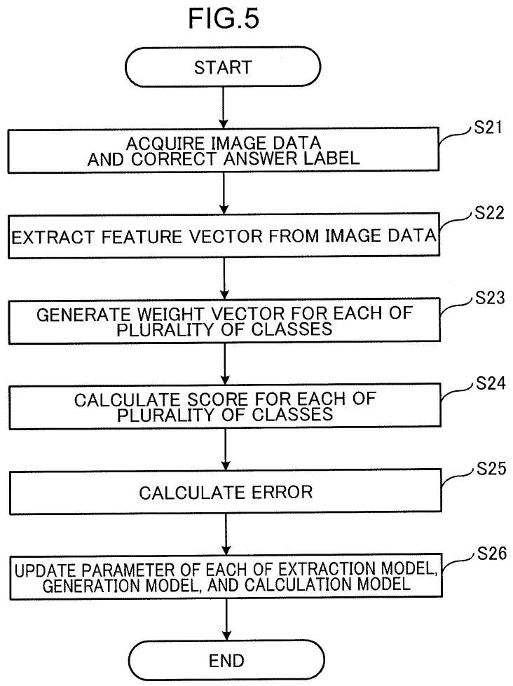

FIG. 5 is a flowchart for explaining an operation of the learning device 2 according to the present embodiment.

First, in step S21, the data acquisition part 17 acquires image data including a class classification target and a correct answer label associated with the class classification target of the image data.

Next, in step S22, the feature amount extraction part 12 extracts a feature vector from the image data acquired by the data acquisition part 17 using the untrained extraction model.

Next, in step S23, the weight generation part 13 uses an untrained generation model to generate, for each of a plurality of classes for classification, a weight vector that continuously changes according to a value of a feature vector.

Next, in step S24, the class score calculation part 14 uses an untrained calculation model to calculate a score for each of a plurality of classes based on the feature vector extracted by the feature amount extraction part 12 and the plurality of weight vectors generated for each of the plurality of classes by the weight generation part 13.

Next, in step S25, the error calculation part 18 calculates an error between the plurality of scores calculated for each of the plurality of classes by the class score calculation part 14 and the correct answer label associated with the classification target of the image data.

Next, in step S26, the parameter update part 19 updates the parameters of each of the extraction model, the generation model, and the calculation model based on the error calculated by the error calculation part 18.

Note that the extraction model, the generation model, and the calculation model are trained by repeatedly performing the processing in steps S21 to S26 using the plurality of pieces of image data and the plurality of correct answer labels. The trained extraction model, generation model, and calculation model are used in the class classification device 1.

As described above, the weight vector continuously changing according to the value of the feature vector is generated for each of the plurality of classes to be classified. Then, a score for each of the plurality of classes is calculated based on the feature vector and the plurality of weight vectors generated for each of the plurality of classes. Then, the parameter of at least one of the generation model and the calculation model is updated based on an error between the plurality of scores calculated for each of the plurality of classes and the correct answer label associated with the classification target of the input data.

Therefore, since the weight vector continuously changing according to the value of the feature vector is generated for each of the plurality of classes to be classified, the generation model and the calculation model trained using the generated weight vector can express a plurality of variations of the feature amount in the class, and class classification can be accurately performed even when the feature amount in the class is distributed in a wide range.

Next, a comparison result between the class classification by the DNC of Non Patent Literature 1 and the class classification by the class classification device 1 according to the present embodiment will be described.

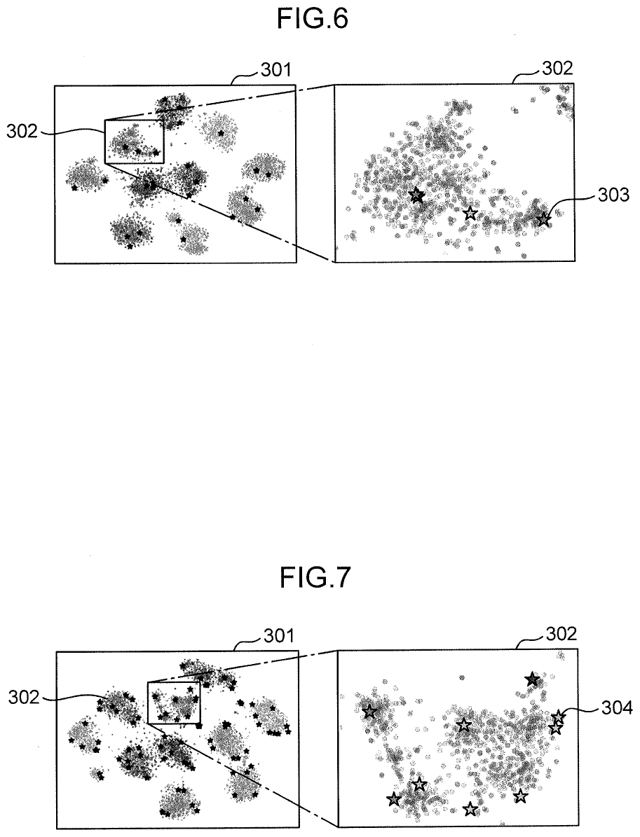

FIG. 6 is a diagram illustrating the distribution of the feature amount on the feature amount space in the class classification by the conventional DNC, and FIG. 7 is a diagram illustrating the distribution of the feature amount on the feature amount space in the class classification by the class classification device 1 according to the present embodiment.

In FIGS. 6 and 7, the CIFAR-10 is used as a data set, and a plurality of pieces of image data are classified into classes indicating airplane, automobile, bird, cat, deer, dog, frog, horse, ship, and truck. Points in FIGS. 6 and 7 indicate distributions of feature amounts in a feature amount space 301, and a plurality of sets of points indicate feature amounts classified into a plurality of classes, respectively. In addition, the zoomed distribution diagram 302 illustrates a feature distribution of a class indicating a bird. A star 303 in FIG. 6 represents the centroid vector of the DNC, and a star 304 in FIG. 7 represents the weight vector (matrix) of the present embodiment.

In the conventional DNC, the input feature amount z belonging to the class c is trained so as to approach any centroid vector w^{c}ᵢ. Furthermore, the centroid vector w^{c}ᵢ is updated by online clustering so as to approach the average vector in each batch. Therefore, as illustrated in FIG. 6, the centroid vector represents the center of each class on the feature amount space 301.

On the other hand, in the present embodiment, the input feature amount z belonging to the class c is trained to be expressed by a linear combination Σa^{c}ᵢW^{c}ᵢ of orthogonal weight vectors {W^{c}₁, W^{c}₂, . . . , W^{c}ₙ}. At this time, since the assignment vector a^{c}=ReLU(W^{c}z) satisfies 0≤a^{c}ᵢ≤1 and ∥a^{c}∥₂≤1, each element W^{c}ᵢ of the matrix represents an edge of each class on the feature amount space 301 as illustrated in FIG. 7. As a result, the present embodiment can acquire fine expressions that cannot be expressed by the DNC.

Next, a verification result of the effectiveness of the present embodiment in the image classification problem will be described. In this verification, three class classification methods of the conventional class classification method (ResNet), the class classification method (DNC) of Non Patent Literature 1, and the class classification method of the present embodiment are compared.

As a data set, CIFAR-100 and ImageNet have been used to evaluate a class classification problem. ResNet-50 and ResNet-101 have been used as a feature amount extraction method. The hyperparameters of the class classification method of the present embodiment are n=10 and κ=50.0. In addition, as the experimental results, the average and standard deviation of three experiments performed by changing random numbers are described.

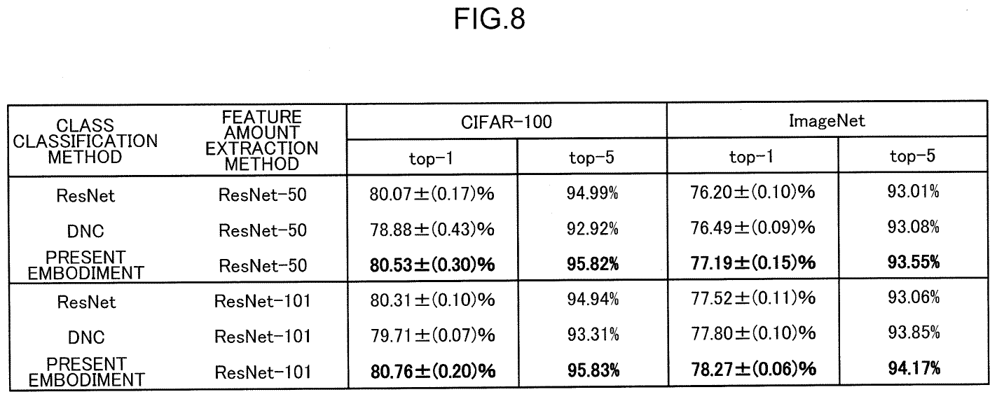

FIG. 8 is a diagram illustrating evaluation results of two conventional class classification methods for two data sets and the class classification method according to the present embodiment. The two data sets are CIFAR-100 and ImageNet, the conventional two class classification methods are ResNet and DNC, and the evaluation indexes are Top-1 Accuracy and Top-5 Accuracy. Top-1 Accuracy is an evaluation index that is determined as a correct answer when a class having the highest probability among the class classification results matches a class of a correct answer label. Top-5 Accuracy is an evaluation index that is determined as a correct answer in a case where a class of a correct answer label is included in the top 5 classes having a high probability among the class classification results.

In CIFAR-100 and ImageNet, the class classification method of the present embodiment exceeds the performance of the conventional ResNet and DNC. In particular, in Top-5 Accuracy of CIFAR-100, the performance of the DNC is deteriorated, whereas in the class classification method of the present embodiment, the performance is improved by 0.8% to 0.9%, and it can be seen that the distance relationship between the feature amounts can be trained more correctly.

Next, another experimental result of the effectiveness of the present embodiment in the image classification problem will be described.

As the class becomes coarser, the intra-class distribution becomes more complex and the feature distribution becomes multimodal. To evaluate the performance with respect to multimodality, experiments have been performed in which the model is trained using a coarse-grained label and evaluated using a fine-grained label. Evaluation on the fine-grained label has been performed using the top-1 nearest neighbor accuracy. Details of the network architecture and learning used in the experiment are similar to those in FIG. 8.

As the data set, CIFAR-100 and ImageNet have been used. In the CIFAR-100, 20 coarse-grained labels (CIFAR-20) and 100 fine-grained labels are set. Furthermore, for ImageNet, 127 coarse-grained labels (ImageNet-127) have been acquired from the 1000 fine-grained labels by performing top-down clustering with a fixed distance from the root node of the WordNet tree.

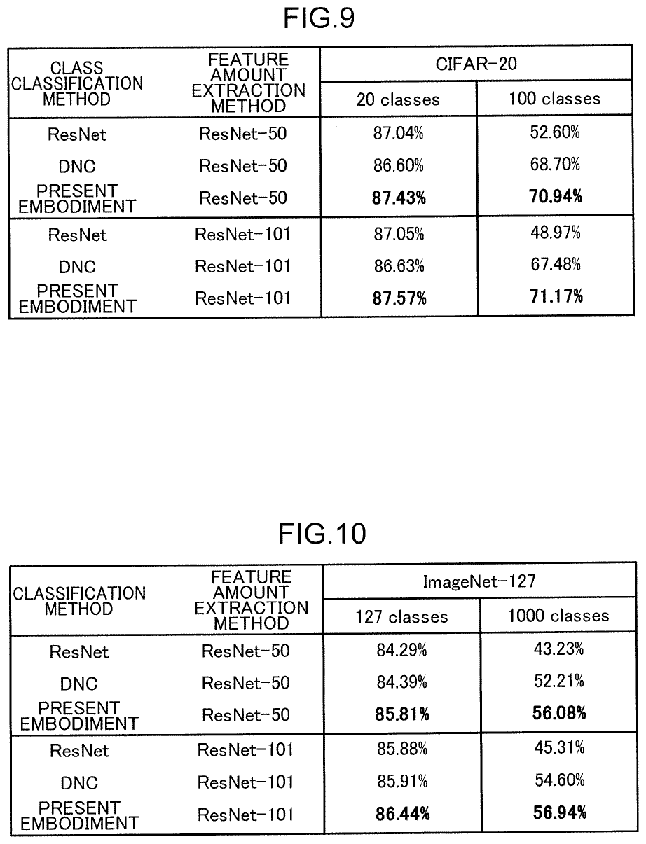

FIG. 9 is a diagram illustrating evaluation results of two conventional class classification methods for two types of labels of CIFAR-20 and the class classification method of the present embodiment. FIG. 10 is a diagram illustrating evaluation results of two conventional class classification methods for two types of labels of ImageNet and the class classification method of the present embodiment. The two types of labels are a coarse-grained label and a fine-grained label.

In CIFAR-20 illustrated in FIG. 9, it can be seen that the class classification method of the present embodiment is superior to the conventional class classification method in the accuracy of the fine-grained label. In addition, in ImageNet-127 illustrated in FIG. 10, it can be seen that the class classification method of the present embodiment is superior to the conventional class classification method in the accuracy of the fine-grained label. From this, it can be seen that the class classification method of the present embodiment can more accurately express the multimodality within the class than the DNC that performs online clustering.

In the present embodiment, the input data is image data, but the present disclosure is not particularly limited thereto, and the input data may be time-series data or audio data.

In the present embodiment, the classification target of the input data is the image data, but the present disclosure is not particularly limited thereto. The classification target of the input data may be each of a plurality of pixels constituting the image data. In addition, the classification target of the input data may be a bounding box surrounding an object included in the image data.

Note that in each of the embodiments, each constituent element may include dedicated hardware or may be implemented by execution of a software program suitable for each constituent element. Each of the constituent elements may be implemented by a program execution unit, such as a CPU or a processor, reading and executing a software program recorded on a recording medium such as a hard disk or a semiconductor memory. The program may be executed by another independent computer system by being recorded in a recording medium and transferred or by being transferred via a network.

Some or all functions of the devices according to the embodiments of the present disclosure are implemented as large scale integration (LSI), which is typically an integrated circuit. These may be individually integrated into one chip, or may be integrated into one chip so as to include some or all of these. Further, the circuit integration is not limited to LSI, and may be realized by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the devices according to the embodiments of the present disclosure may be implemented by a processor such as a CPU executing a program.

The numerical figures used above are all illustrated to specifically describe the present disclosure, and the present disclosure is not limited to the illustrated numerical figures.

The order in which each step illustrated in the above flowcharts is performed is for specifically describing the present disclosure, and may be an order other than the above order as long as a similar effect can be obtained. Some of the above steps may be executed simultaneously (in parallel) with other steps.

Since the technology according to the present disclosure can accurately perform class classification even in a case where feature amounts in a class are distributed in a wide range, the technology according to the present disclosure is useful as a technology for performing class classification using a deep learning model and a technology for training a deep learning model used for performing class classification.

1. A class classification method executed by a computer, comprising:
acquiring a feature vector extracted from input data;
generating a weight vector continuously changing according to a value of the feature vector for each of a plurality of classes to be classified using a trained generator;
calculating a score for each of the plurality of classes based on the feature vector and a plurality of weight vectors generated for each of the plurality of classes using a trained calculator;
classifying a classification target of the input data into any one of the plurality of classes based on a plurality of scores calculated for each of the plurality of classes; and
outputting a classification result.

2. The class classification method according to claim 1, wherein
the generator has a matrix including a plurality of row vectors as a parameter for each class of the plurality of classes, and
the generating of the weight vector includes generating the weight vector for each class using the value of the feature vector and the matrix.

3. The class classification method according to claim 2, wherein the generating of the weight vector includes, for each class of the plurality of classes, calculating a weight of a linear combination for each of a plurality of row vectors constituting a matrix allocated to each class from a value of the feature vector and the plurality of row vectors, and generating a weight vector for each class by linearly combining the plurality of row vectors using the weight.

4. The class classification method according to claim 2, wherein the matrix is an orthonormal matrix.

5. The class classification method according to claim 3, wherein each element of the weights of the linear combination is positive.

6. The class classification method according to claim 1, wherein the input data is image data.

7. The class classification method according to claim 6, wherein the classification target of the input data is the image data.

8. The class classification method according to claim 6, wherein the classification target of the input data is each of a plurality of pixels constituting the image data.

9. The class classification method according to claim 6, wherein the classification target of the input data is a bounding box surrounding an object included in the image data.

10. The class classification method according to claim 1, wherein the input data is time-series data.

11. A learning method executed by a computer, comprising:
acquiring a feature vector extracted from input data;
generating a weight vector that continuously changes according to a value of the feature vector for each of a plurality of classes to be classified using an untrained generator;
calculating a score for each of the plurality of classes based on the feature vector and a plurality of weight vectors generated for each of the plurality of classes using an untrained calculator;
calculating an error between a plurality of scores calculated for each of the plurality of classes and a correct answer label associated with a classification target of the input data; and
updating a parameter of at least one of the generator and the calculator based on the error.

12. The learning method according to claim 11, wherein
the generator has a matrix including a plurality of row vectors as a parameter for each class of the plurality of classes, and
the generating of the weight vector includes generating the weight vector for each class using the value of the feature vector and the matrix.

13. The learning method according to claim 12, wherein the generating of the weight vector includes, for each class of the plurality of classes, calculating a weight of a linear combination for each of a plurality of row vectors constituting a matrix allocated to each class from a value of the feature vector and the plurality of row vectors, and generating a weight vector for each class by linearly combining the plurality of row vectors using the weight.

14. The learning method according to claim 12, wherein the matrix is an orthonormal matrix.

15. The learning method according to claim 13, wherein each element of the weights of the linear combination is positive.

16. The learning method according to claim 11, further comprising extracting the feature vector from the input data using an untrained extractor,
wherein the updating of the parameter includes simultaneously updating the parameter of each of the extractor, the generator, and the calculator based on the error.

17. A class classification device comprising:
an acquisition part that acquires a feature vector extracted from input data;
a generation part that generates a weight vector continuously changing according to a value of the feature vector for each of a plurality of classes to be classified using a trained generator;
a score calculation part that calculates a score for each of the plurality of classes based on the feature vector and a plurality of weight vectors generated for each of the plurality of classes using a trained calculator;
a classification part that classifies a classification target of the input data into any one of the plurality of classes based on a plurality of scores calculated for each of the plurality of classes; and
an output part that outputs a classification result.

18. A non-transitory computer readable recording medium storing a class classification program for causing a computer to execute:
acquiring a feature vector extracted from input data;
generating a weight vector continuously changing according to a value of the feature vector for each of a plurality of classes to be classified using a trained generator;
calculating a score for each of the plurality of classes based on the feature vector and a plurality of weight vectors generated for each of the plurality of classes using a trained calculator;
classifying a classification target of the input data into any one of the plurality of classes based on a plurality of scores calculated for each of the plurality of classes; and
outputting a classification result.

19. A learning device comprising:
an acquisition part that acquires a feature vector extracted from input data;
a generation part that generates a weight vector that continuously changes according to a value of the feature vector for each of a plurality of classes to be classified using an untrained generator;
a score calculation part that calculates a score for each of the plurality of classes based on the feature vector and a plurality of weight vectors generated for each of the plurality of classes using an untrained calculator;
an error calculation part that calculates an error between a plurality of scores calculated for each of the plurality of classes and a correct answer label associated with a classification target of the input data; and
an update part that updates a parameter of at least one of the generator and the calculator based on the error.

20. A non-transitory computer readable recording medium storing a learning program for causing a computer to execute:
acquiring a feature vector extracted from input data;
generating a weight vector that continuously changes according to a value of the feature vector for each of a plurality of classes to be classified using an untrained generator;
calculating a score for each of the plurality of classes based on the feature vector and a plurality of weight vectors generated for each of the plurality of classes using an untrained calculator;
calculating an error between a plurality of scores calculated for each of the plurality of classes and a correct answer label associated with a classification target of the input data; and
updating a parameter of at least one of the generator and the calculator based on the error.
